(19) United States
(12) Patent Application Publication
(10) Pub. No.: US 2017/0062100 A1
(43) Pub. Date: Mar. 2, 2017

(54) METHOD FOR MANUFACTURING MULTILAYER SUBSTRATE

(71) Applicant: MURATA MANUFACTURING CO., LTD., Nagaokayo-shi (JP)

(72) Inventor: Kuniaki YOSUI, Nagaokakyo-shi (JP)

(21) Appl. No.: 14/833,191

(22) Filed: Aug. 24, 2015

(51) Int. Cl. H01B 13/00; H01B 13/06

(52) U.S. Cl. CPC H01B 13/0036; H01B 13/0016; H01B 13/06

(57) ABSTRACT

In a method for manufacturing a multilayer substrate, first, a via hole is formed in a first insulating layer and a second insulating layer and filled with conductive paste. Subsequently, the first insulating layer and the second insulating layer are stacked on each other. Next, the conductive paste is cured to form a via conductor while the first insulating layer and the second insulating layer are integrated through thermal pressing. Then, a penetrating hole that penetrates the via conductor in the laminating direction is formed.

### BACKGROUND OF THE INVENTION

1. Field of the Invention

The present invention relates to a method for manufacturing multilayer substrates including interlayer connection conductors.

2. Description of the Related Art

In some conventional multilayer substrates, layers may have been connected by a metal film that forms an inner wall of a through hole. As a method for manufacturing a through hole that connects the upper surface and the lower surface of a substrate, for example, Japanese Unexamined Patent Application Publication No. 2006-012895 discloses a method for manufacturing a semiconductor device. In the method for manufacturing a semiconductor device, an inorganic insulating layer is formed on the inner wall of a penetrating hole of a semiconductor substrate to form an organic insulating layer on the inorganic insulating layer via an adhesion promoting layer. Then, on the organic insulating layer, a conductive layer that connects the upper surface side and the lower surface side of the semiconductor substrate is formed by electroless plating.

The method disclosed in Japanese Unexamined Patent Application Publication No. 2006-012895, however, requires a surface treatment of the penetrating hole by forming the inorganic insulating layer, the adhesion promoting layer, and the organic insulating layer, as a pre-treatment to form the conductive layer. In addition, in order to form the conductive layer in the penetrating hole, the method uses electroless plating in which the growth of a plated layer is slow. Therefore, the method disclosed in Japanese Unexamined Patent Application Publication No. 2006-012895 requires time and effort when forming a conductive layer in a penetrating hole.

### SUMMARY OF THE INVENTION

Preferred embodiments of the present invention provide a method for manufacturing a multilayer substrate, the method being capable of easily forming an interlayer connection conductor on a multilayer substrate.

A method for manufacturing a multilayer substrate according to a preferred embodiment of the present invention includes the steps of forming a via hole in a base material; forming an interlayer connection conductor in the via hole; stacking and integrating a plurality of the base materials on which the interlayer connection conductor is formed; and causing a portion of a region in which the interlayer connection conductor is formed to be penetrated in a laminating direction.

In this configuration, by forming the penetrating hole that penetrates the interlayer connection conductor in the laminating direction, the penetrating hole (through hole) is able to be formed so that the interlayer connection conductor may be exposed to the inner wall of the through hole. This forms a through hole of which the inner wall is provided with an interlayer connection conductor. Therefore, since it is not necessary to perform electroless plating and a pretreatment of the electroless plating in order to form the through hole of which the inner wall is provided with the interlayer connection conductor, a through hole of which the inner wall is provided with the interlayer connection conductor is able to be formed easily.

A method for manufacturing a multilayer substrate according to a preferred embodiment of the present invention may further preferably include a step of growing a metal film on the interlayer connection conductor exposed to an inner side of a penetrated portion of the region. In this configuration, since the layers of the multilayer substrate is connected by a metal film of which the conductor resistance is small compared with the interlayer connection conductor, power loss in an interlayer connection portion is significantly reduced.

In a method for manufacturing a multilayer substrate according to a preferred embodiment of the present invention, the base material may preferably include a first main surface on which conductive foil is formed; and a second main surface on which no conductive foil is formed, and in the step of stacking and integrating the plurality of the base materials, the base materials may preferably be stacked with second main surfaces of the base materials faced each other so that a plurality of the interlayer connection conductors may be overlapped in a plan view. In this configuration, the conductive foils located apart from each other by two layers in the laminating direction are able to be connected.

In a method for manufacturing a multilayer substrate according to a preferred embodiment of the present invention, the base material may preferably include a main surface on which conductive foil is formed; and the conductive foil may preferably include a first main surface that is in contact with the base material; and a second main surface that is not in contact with the base material, and surface roughness of the first main surface may preferably be larger than surface roughness of the second main surface. In this configuration, it is possible to ensure the joining strength of the conductive foil and the insulating layer and to prevent the conductor resistance from deteriorating.

In a method for manufacturing a multilayer substrate according to a preferred embodiment of the present invention, the base material may preferably include a main surface on which metal foil is formed; and in the step of stacking and integrating the plurality of the base materials, first metal included in the metal foil and second metal included in the interlayer connection conductor may preferably form a solid phase diffusion layer between the metal foil and the interlayer connection conductor. In this configuration, the metal foil and the interlayer connection conductor are joined by metallic bonding, which increases the joining strength between the metal foil and the interlayer connection conductor.

In a method for manufacturing a multilayer substrate according to a preferred embodiment of the present invention, in the step of stacking and integrating the plurality of the base materials, a plurality of the interlayer connection layers formed on the base materials may preferably be joined to form an interlayer connection conductor of which opposite end portions may preferably be thinner than a central portion of the interlayer connection conductor, in the laminating direction of the base materials. In this configuration, the interlayer connection conductor is able to be made to hardly come off from the base material. This configuration is in particular effective for a case in which a flexible substrate (base material with flexibility) is used, a case in which a penetrating hole that penetrates an interlayer connection conductor is formed, and the like.

According to various preferred embodiments of the present invention, it is possible to easily form an interlayer connection conductor on a multilayer substrate.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1A is an external perspective view showing a vicinity of an end portion of a flexible cable according to a preferred embodiment of the present invention.

FIG. 1B is an exploded perspective view showing the vicinity of the end portion of the flexible cable according to a preferred embodiment of the present invention.

FIG. 2 is an exploded plan view showing the vicinity of the end portion of the flexible cable according to a preferred embodiment of the present invention.

FIG. 3 is a schematic sectional view taken along line A-A of the flexible cable according to a preferred embodiment of the present invention.

FIG. 4A to FIG. 4G are schematic sectional views showing a method for manufacturing the flexible cable according to a preferred embodiment of the present invention.

FIG. 5A and FIG. 5B are schematic sectional views showing the method for manufacturing the flexible cable according to a preferred embodiment of the present invention.

FIG. 6A and FIG. 6B are schematic sectional views showing a method for joining the flexible cable according to a preferred embodiment of the present invention and a circuit substrate.

FIG. 7A to FIG. 7C are schematic sectional views showing a method for manufacturing a flexible cable according to a first modification of a preferred embodiment of the present invention.

FIG. 8A is a schematic sectional view of a flexible cable according to a second modification of a preferred embodiment of the present invention.

FIG. 8B is a plan view showing a vicinity of an end portion of a flexible cable according to a third modification of a preferred embodiment of the present invention.

FIG. 8C is a schematic sectional view taken along line B-B of a flexible cable according to the third modification of a preferred embodiment of the present invention.

FIG. 8D is an exploded plan view showing a vicinity of an end portion of a flexible cable according to a fourth modification of a preferred embodiment of the present invention.

### DETAILED DESCRIPTION OF THE PREFERRED EMBODIMENTS

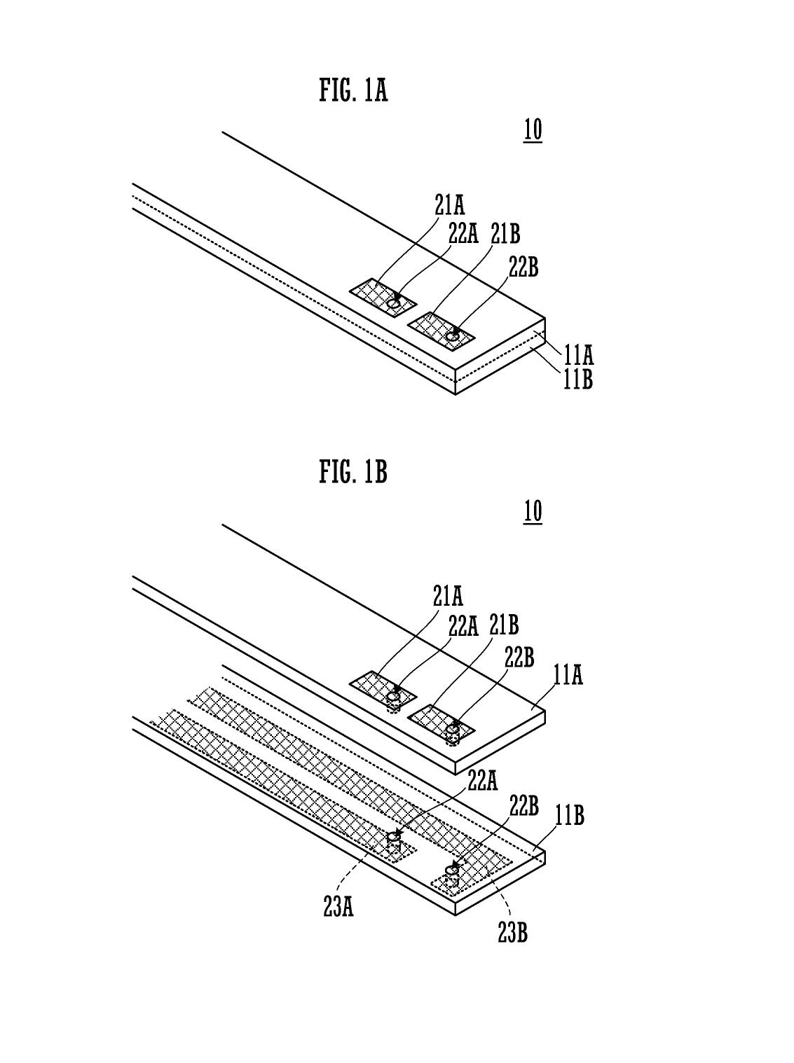

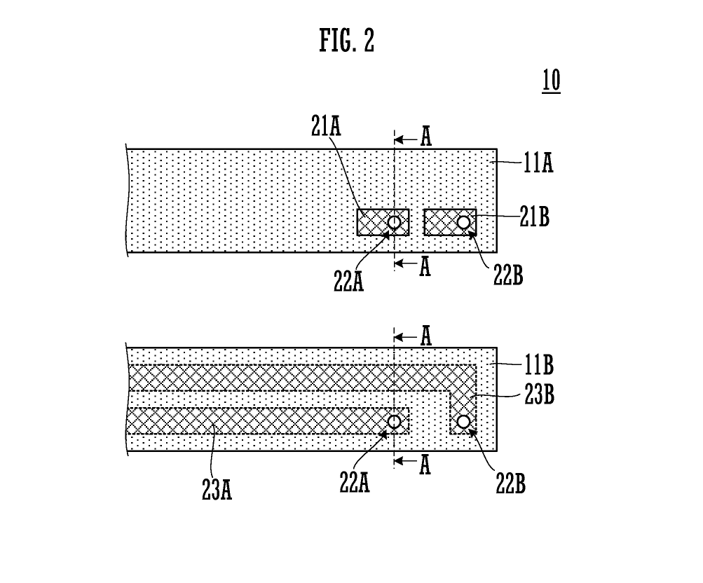

Hereinafter, a flexible cable 10 according to a preferred embodiment of the present invention will be described. The flexible cable 10 is an example of a multilayer substrate of the present invention. FIG. 1A is an external perspective view showing a vicinity of an end portion of the flexible cable 10. FIG. 1B is an exploded perspective view showing the vicinity of the end portion of the flexible cable 10. FIG. 2 is an exploded plan view showing the vicinity of the end portion of the flexible cable 10.

The flexible cable 10 preferably has a rectangular or substantially rectangular plate-shaped configuration and extends in the longitudinal direction. The flexible cable 10 includes an insulating layer (base material) 11A and an insulating layer 11B that are laminated on each other. In the flexible cable 10, the insulating layer 11A is stacked on the upper surface of the insulating layer 11B. The flexible cable 10 includes an external electrode 21A and an external electrode 21B that are located on the upper surface of the end portion of the flexible cable 10. The flexible cable 10 includes a through hole 22A that is located toward the laminating direction in a position in which the through hole 22A and the external electrode 21A are overlapped in a plan view, and a through hole 22B that is located toward the laminating direction in a position in which the through hole 22B and the external electrode 21B are overlapped in a plan view.

The insulating layer 11A and the insulating layer 11B each preferably have a rectangular or substantially rectangular plate-shaped configuration and extend long in the longitudinal direction. The insulating layer 11A and the insulating layer 11B preferably are made of thermoplastic resin such as a liquid crystal (LCP) and polyimide (PI). The external electrode 21A and the external electrode 21B each preferably have a rectangular or substantially rectangular plate-shaped configuration and are arranged side by side in the longitudinal direction of the insulating layer 11A so that the long sides of the external electrodes 21A and 21B may be along the long side of the insulating layer 11A.

The insulating layer 11B includes a linear conductor 23A and a linear conductor 23B that are located on the lower surface of the insulating layer 11B. The linear conductor 23A extends in the longitudinal direction of the insulating layer 11B. The end portion of the linear conductor 23A is overlapped with the through hole 22A in a plan view. The linear conductor 23B extends in parallel or substantially parallel to the linear conductor 23A. A portion of the linear conductor 23B extends in the transverse direction of the insulating layer 11B at the end portion of the insulating layer 11B. The end portion of the linear conductor 23B is overlapped with the through hole 22B in a plan view. The insulating layer 11B includes resist (not shown) that protects the linear conductor 23A and the linear conductor 23B, on the lower surface of the insulating layer 11B.

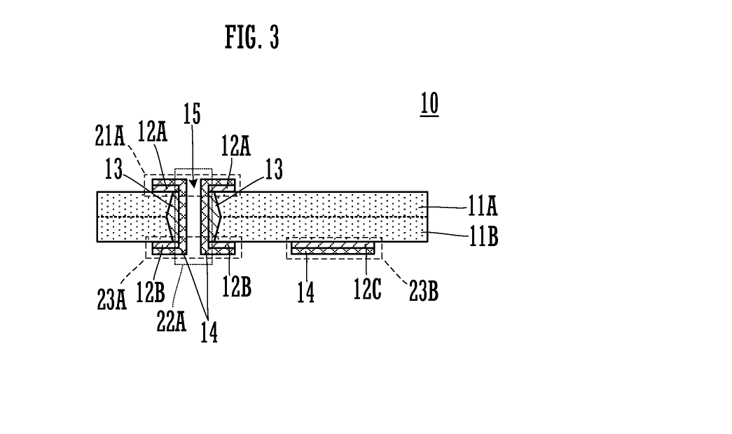

FIG. 3 is a schematic sectional view taken along line A-A of the flexible cable 10. The external electrode 21A and the linear conductor 23A are connected by the inner wall portion of the through hole 22A. The external electrode 21A is preferably made of conductive foil 12A covered with a plating film (metal film) 14. The linear conductor 23A is preferably made of conductive foil 12B covered with the plating film 14. The linear conductor 23B is preferably made of conductive foil 12C covered with the plating film 14. The inner wall of the through hole 22A is covered with the plating film 14. The conductive foil 12A, the conductive foil 12B, and the conductive foil 12C are made of metal foil such as copper foil. The plating film 14 is preferably made of an electrolytically plated (electrodeposited) metal film and the like.

The conductive foil 12A is located on the upper surface of the insulating layer 11A. The conductive foil 12B is located on the lower surface of the insulating layer 11B so as to be overlapped with the conductive foil 12A in a plan view. The conductive foil 12A and the conductive foil 12B are connected by a via conductor (interlayer connection conductor) 13. The via conductor 13 is formed preferably by curing conductive paste filled in the via hole. The via conductor 13 penetrates the insulating layer 11A and the insulating layer 11B and is overlapped with the conductive foil 12A and the conductive foil 12B in a plan view. The via conductor 13 tapers from the lower surface to the upper surface of the insulating layer 11A and tapers from the upper surface to the lower surface of the insulating layer 11B.

In a plan view, a penetrating hole 15 is formed in the central portion of the through hole 22A. The penetrating hole 15 is formed by penetrating the conductive foil 12A, the conductive foil 12B, and the via conductor 13 in the laminating direction. In other words, the penetrating hole 15 is formed by penetrating in the laminating direction a portion of a region in which the via conductor 13 is formed. The plating film 14 continuously covers the conductive foil 12A, the conductive foil 12B, and the inner wall of the penetrating hole 15. The conductive foil 12A and the conductive foil 12B are connected by the plating film 14. The conductor resistance of the plating film 14 is smaller than the conductor resistance of the via conductor 13. It is to be noted that the through hole 22B is preferably formed in the same manner as the through hole 22A. The external electrode 21B is preferably formed in the same manner as the external electrode 21A.

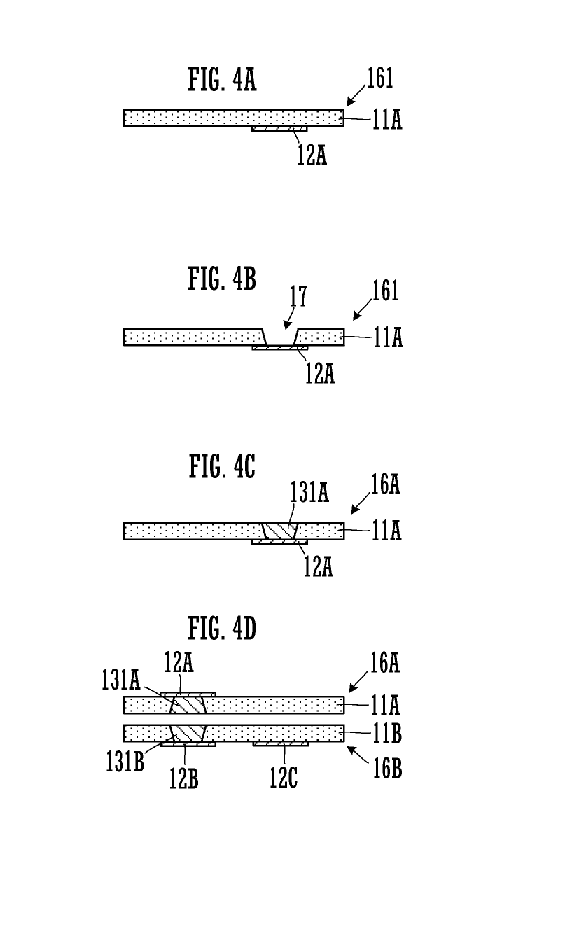

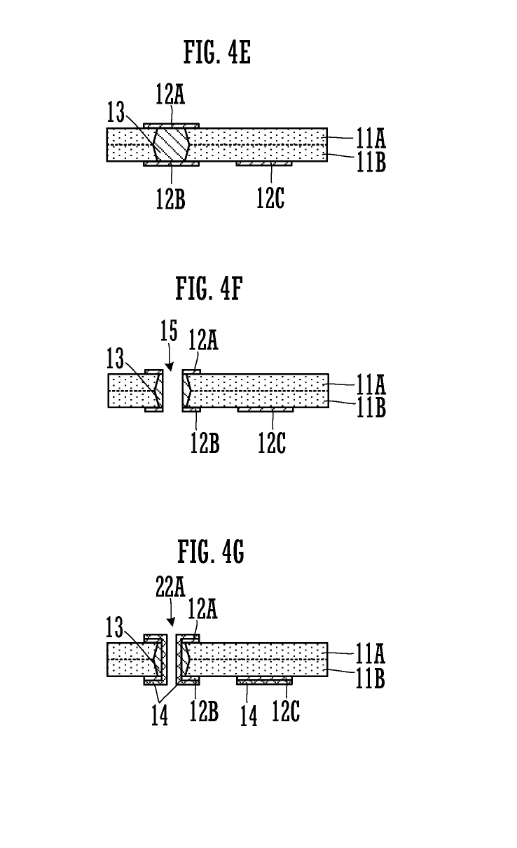

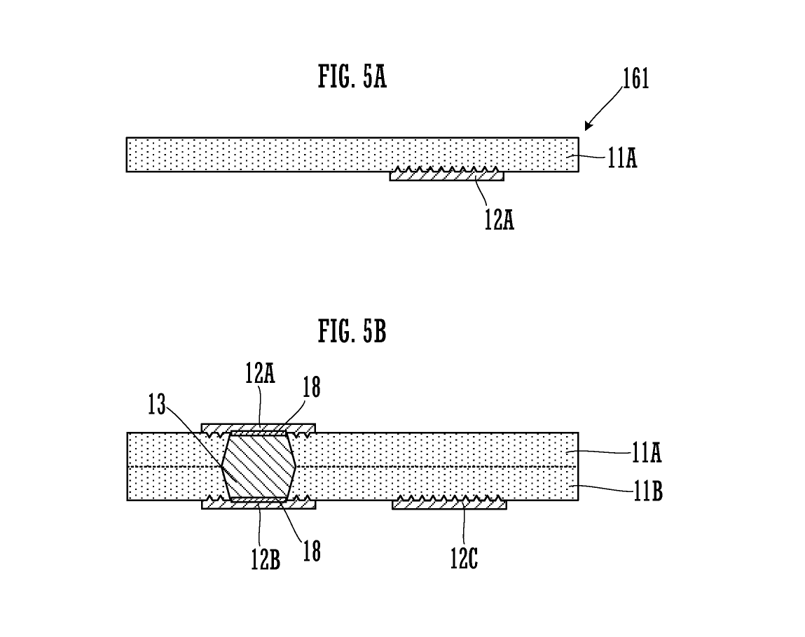

FIG. 4A to FIG. 4G are schematic sectional views showing a method for manufacturing the flexible cable 10. FIG. 5A is a schematic sectional view corresponding to FIG. 4A. In FIG. 5A, the surface roughness of the conductive foil is emphasized. FIG. 5B is a schematic sectional view corresponding to FIG. 4E. In FIG. 5B, a solid phase diffusion layer located between the conductive foil and the via conductor is clearly specified. To begin with, as shown in FIG. 4A, a one side copper-clad base material 161 is prepared. The one side copper-clad base material 161 is made of the insulating layer 11A of which one side (only one main surface) includes the conductive foil 12A and conductive foil for the external electrode 21B (see FIG. 1A). It should be noted that, while, in the present preferred embodiment, the conductive foil 12A preferably is copper foil, the conductive foil is not limited to copper foil. Hereinafter, of the two main surfaces of the one side copper-clad base material, a main surface on which conductive foil is formed is referred to as a first main surface and a main surface on which no conductive foil is formed is referred to as a second main surface.

As shown in FIG. 5A, the surface roughness of the conductive foil 12A is large on the main surface in contact with the insulating layer 11A, and small on the main surface in non-contact with the insulating layer 11A. This also applies to other conductive foil. In other words, of the main surfaces of the conductive foil, the surface roughness of the main surface in contact with the insulating layer on which the conductive foil is formed is larger than the surface roughness of the main surface (the main surface on the opposite side of the main surface in contact with the insulating layer) in non-contact with the insulating layer on which the conductive foil is formed. This makes it possible to ensure the joining strength of the conductive foil and the insulating layer according to the largeness of the surface roughness of the main surface in contact with the insulating layer on which the conductive foil is formed and to prevent the conductor resistance of the conductive foil from greatly deteriorating by making the surface roughness relatively small on the main surface in non-contact with the insulating layer on which the conductive foil is formed.

Subsequently, as shown in FIG. 4B, a via hole 17 is formed in the insulating layer 11A. Specifically, from the second main surface of the one side copper-clad base material 161 toward the first main surface of the one side copper-clad base material 161, a position in which a through hole is desired to be formed is irradiated with a laser beam. In such a case, the output of the laser beam is adjusted so that the laser beam penetrates the insulating layer 11A while not penetrating the conductive foil 12A. Accordingly, on the one side copper-clad base material 161, the via hole 17 that penetrates the insulating layer 11A from the second main surface to the first main surface and that has a bottom surface made of the conductive foil 12A is formed. The via hole 17 tapers (has a tapered shape) from the second main surface side to the first main surface side. It is to be noted that, in order to form the via hole 17, other techniques such as etching may be used in place of laser machining.

Next, as shown in FIG. 4C, the via hole 17 is filled (formed) with conductive paste 131A. The conductive paste 131A is preferably made of a conductive material including tin and copper as main components, for example. This forms a one side copper-clad base material 16A in which the conductive paste 131A is filled in the via hole 17.

Subsequently, as shown in FIG. 4D, in a step similar to the step of forming the one side copper-clad base material 16A, a one side copper-clad base material 16B is prepared. The one side copper-clad base material 16B is made of the insulating layer 11B of which one side includes the conductive foil 12B and the conductive foil 12C. In the one side copper-clad base material 16B, a via hole is formed so as to be overlapped with the conductive foil 12B in a plan view and conductive paste 131B is filled with the via hole. Then, the second main surfaces of the one side copper-clad base material 16A and the one side copper-clad base material 16B are made to face each other to stack the one side copper-clad base material 16A and the one side copper-clad base material 16B. In such a case, in a plan view, the conductive paste 131A and the conductive paste 131B with which the via hole is filled are made overlapped with each other. In this way, the stack of the one side copper-clad base materials 16A and 16B, as described below, causes the via conductor 13 formed through a thermal pressing step to be barrel-shaped.

Next, as shown in FIG. 4E, at a temperature at which the thermoplastic resin that configures the insulating layer 11A and the insulating layer 11B is sufficiently softened, the one side copper-clad base material 16A and the one side copper-clad base material 16B that have been stacked are thermally pressed. Accordingly, the insulating layer 11A and the insulating layer 11B are integrated. Additionally, in this step, the conductive paste 131A and the conductive paste 131B are cured and integrated to form the via conductor 13. Moreover, as shown in FIG. 5B, a solid phase diffusion layer 18 is formed between the conductive foils 12A and 12B and the via conductor 13. Accordingly, in the thermal pressing step, the conductive foils and the via conductor are joined through the solid phase diffusion layer while the via conductors that are in contact with each other are joined together. For example, Cu (first metal) as the material of conductive foil and Sn (second metal) included in the via conductor provide the solid phase diffusion layer of Cu₆Sn₅. Since this joins the conductive foil and the via conductor by metal coupling, the joining strength between the conductive foil and the via conductor can be increased.

The via conductor 13 preferably is barrel-shaped and, in the laminating direction of the insulating layer 11A and the insulating layer 11B, is thick in the central portion and becomes thinner toward the opposite end portions. The barrel shape of the via conductor positioned between the conductive foils makes the via conductor hardly come off from the insulating layer. The barrel-shaped via conductor is in particular effective for a case in which a flexible substrate (insulating layer with flexibility) is used, a case in which a penetrating hole that penetrates a via conductor is formed as described below, and the like.

In this way, the insulating layer 11A on which the conductive paste 131A is formed and the insulating layer 11B on which the conductive paste 131B is formed are stacked and integrated. In the step of stacking and integrating the insulating layer 11A and the insulating layer 11B, the main surfaces of the insulating layer 11A and the insulating layer 11B are made to face each other, the main surfaces including no conductive foil, and, in a plan view, the insulating layer 11A and the insulating layer 11B are stacked so that the conductive paste 131A and the conductive paste 131B are overlapped with each other.

Subsequently, as shown in FIG. 4F, through laser machining, a penetrating hole 15 that is positioned in the central portion of the via conductor 13 in a plan view and that penetrates the conductive foil 12A, the conductive foil 12B, and the via conductor 13 in the laminating direction is formed. In other words, the penetrating hole 15 is formed so as to penetrate in the laminating direction a portion of a region in which the via conductor 13 is formed. It should be noted that other machining such as extrusion machining may be used in place of the laser machining. However, the use of the laser machining, will not damage or destroy the via conductor 13 due to the mechanical force applied to the via conductor 13.

Next, as shown in FIG. 4G, by electrolytic plating, a plating film 14 is formed on the conductive foil 12A, the conductive foil 12B, the conductive foil 12C, and the inner wall of the penetrating hole 15. In other words, the plating film 14 is grown on the via conductor 13 exposed to the inside of the region penetrated by the penetrating hole 15. This forms the through hole 22A of which the inner wall is covered with the plating film 14. It is to be noted that, since the inner wall of the penetrating hole 15 is preferably formed by the via conductor 13 as a conductor, it is not necessary to perform electroless plating before performing electrolytic plating.

The through hole 22B (see FIG. 1A) is formed in a step similar to the step of forming the through hole 22A in parallel to the step of forming the through hole 22A. Through the above steps, the flexible cable 10 is completed.

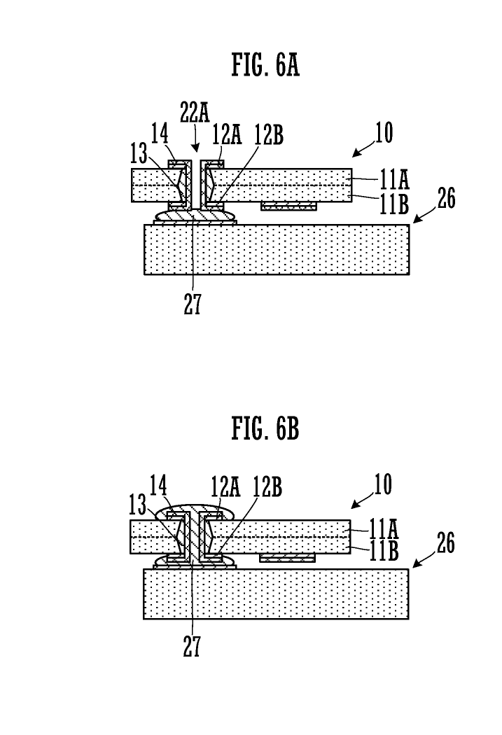

FIG. 6A and FIG. 6B are schematic sectional views showing a method for joining the flexible cable 10 and a circuit substrate 26. To begin with, as shown in FIG. 6A, solder 27 is printed on an electrode formed on the upper surface of the circuit substrate 26. Then, the flexible cable 10 is arranged on the upper surface of the circuit substrate 26 so that the through hole 22A of the flexible cable 10 and the solder 27 may be overlapped with each other in a plan view. Subsequently, as shown in FIG. 6B, the solder 27 is melted by reflow heating. Since the plating film 14 is formed on the inner wall surface of the through hole 22A, the solder 27 is wet and spread in the through hole 22A with excellent wettability. The solder 27 reaches the upper surface of the flexible cable 10 while being filled in the through hole 22A. Thus, the flexible cable 10 and the circuit substrate 26 are joined.

In the present preferred embodiment, as described with FIG. 4F, by forming the penetrating hole 15 that penetrates the via conductor 13 in the laminating direction, the penetrating hole 15 (through hole 22A) can be formed so that the via conductor 13 may be exposed to the inner wall of the through hole. This forms the through hole 22A of which the inner wall is provided with the via conductor 13. Therefore, since it is not necessary to perform electroless plating and a pretreatment of the electroless plating in order to form a through hole of which the inner wall is provided with an interlayer connection conductor, a through hole of which the inner wall is provided with an interlayer connection conductor is able to be formed easily. It should be noted that, since the electroless plating becomes more difficult to be performed as a multilayer substrate is thicker, various preferred embodiments of the present invention is particularly useful with respect to a thick multilayer substrate.

In addition, as described with FIG. 3, the conductive foil 12A and the conductive foil 12B, while being connected by the via conductor 13, is also connected by the plating film 14 of which the conductor resistance is small compared with the via conductor 13. Therefore, in the present preferred embodiment, power loss in the through hole 22A is significantly reduced compared with a case in which the plating film 14 is not formed.

Moreover, as described with FIG. 6A and FIG. 6B, since the plating film 14 is formed on the inner wall surface of the through hole 22A, the solder 27 is easily wet and spread in the through hole 22A. Therefore, the inner wall of the through hole 22A covered with the plating film 14, and the solder 27 are reliably joined, so that firm joining through the through hole 22A is able to be performed. Furthermore, whether the solder 27 is wet in the through hole 22A can be confirmed when viewed from above.

It is to be noted that, in the present preferred embodiment, since the layers are connected by the via conductor 13, the plating film 14 does not necessarily have to be formed. In such a case, electrolytic plating becomes unnecessary, so that the number of steps is able to be reduced.

Subsequently, modifications of the preferred embodiments of the present invention will be described. Hereinafter, a difference from the flexible cable 10 in the modifications of the present preferred embodiments will be described. It should be noted that the formation of the plating film is omitted in the modifications of the present preferred embodiments. In addition, in the modifications of the present preferred embodiments, only the main portions of the flexible cable are illustrated.

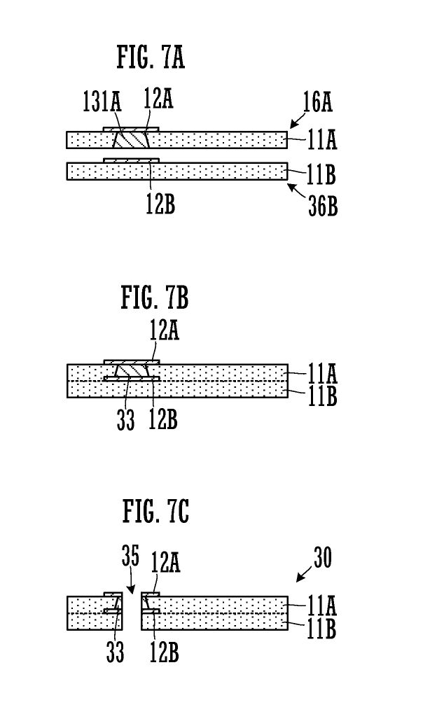

A flexible cable according to a first modification of a preferred embodiment of the present invention includes a through hole that connects conductive foils located apart from each other by one layer in the laminating direction. FIG. 7A to FIG. 7C are schematic sectional views showing a method for manufacturing the flexible cable 30 according to the first modification. As shown in FIG. 7A, the one side copper-clad base material 16A and the one side copper-clad base material 36B are stacked so that the second main surface of the one side copper-clad base material 16A and the first main surface of the one side copper-clad base material 36B face each other. The insulating layer 11B includes no via hole or no conductive paste formed in a portion in which the conductive paste 131A is positioned in a plan view.

Subsequently, as shown in FIG. 7B, the one side copper-clad base material 16A and the one side copper-clad base material 36B that have been laminated are thermally pressed. The conductive paste 131A is cured to form the via conductor 33. Then, as shown in FIG. 7C, a penetrating hole 35 that penetrates the insulating layer 11B, the conductive foil 12A, the conductive foil 12B, and the via conductor 33 in the laminating direction is formed. Through the above steps, the flexible cable 30 is formed.

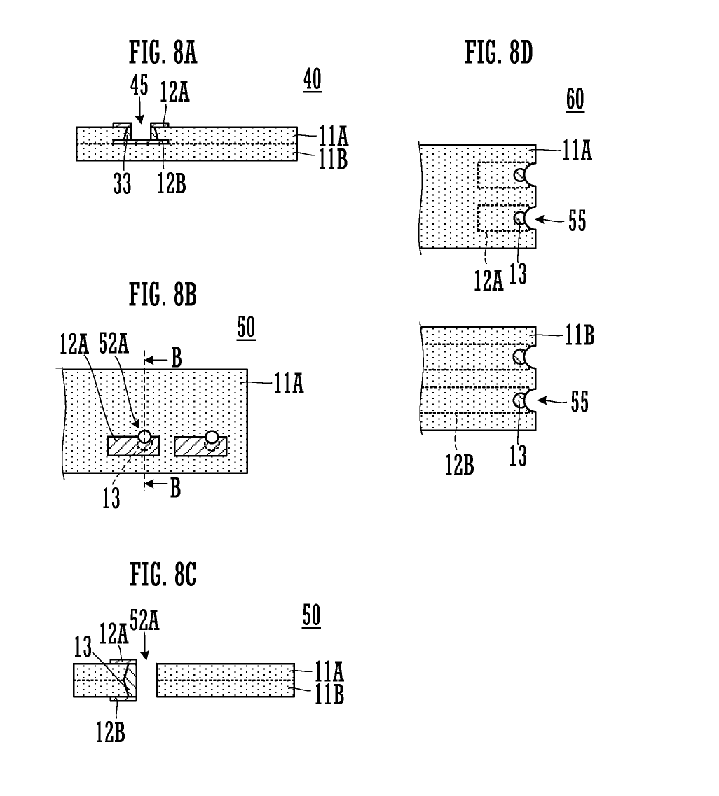

FIG. 8A is a schematic sectional view of a flexible cable 40 according to a second modification of a preferred embodiment of the present invention. In the flexible cable 40, a penetrating hole 45 that penetrates only the conductive foil 12A and the via conductor 33 and does not penetrate the insulating layer 11B and the conductive foil 12B is formed. In other words, the flexible cable 40 includes a cavity of which the side surface is defined by the via conductor 33 and of which the bottom surface is defined by the conductive foil 12B. Other configurations are the same as the configurations of the flexible cable 30 according to the first modification. In order to form the penetrating hole 45, the output of a laser beam may be adjusted so that the laser beam may not penetrate the conductive foil 12B and the insulating layer 11B.

FIG. 8B is a plan view showing a vicinity of an end portion of a flexible cable 50 according to a third modification of a preferred embodiment of the present invention. FIG. 8C is a schematic sectional view taken along line B-B of a flexible cable 50 according to the third modification. In the flexible cable 50, a portion of the inner wall of the through hole 52A is defined by the via conductor 13, and other portions of the inner wall of the through hole 52A are defined by the insulating layer 11A and the insulating layer 11B. In the flexible cable 50, the portion defined by the via conductor 13 and included in the inner wall of the through hole 52A connects the layers. In order to form the through hole 52A, a spot that is irradiated with a laser beam may be shifted from the central portion of the via conductor 13 in a plan view. It should be noted that the flexible cable 50 includes one more structure same as the structure of the through hole 52A.

FIG. 8D is a schematic exploded view of a flexible cable 60 according to a fourth modification of a preferred embodiment of the present invention. On the end portion of the flexible cable 60, the conductive foil 12A, the end portion of the conductive foil 12B, and the via conductor 13 are formed. In the flexible cable 60, cutout portions 55 are formed on the end surfaces of the insulating layer 11A and the insulating layer 11B so as to penetrate in the laminating direction a portion of a region in which the via conductor 13 is formed. It is to be noted that the one more same structure as the structure of the cutout portions 55 is formed on the end surfaces of the insulating layer 11A and the insulating layer 11B.

Finally, the above described preferred embodiments are to be considered in all respects as illustrative and not restrictive. The scope of the present invention is defined by the following claims, not by the foregoing preferred embodiments. Further, the scope of the present invention is intended to include the scopes of the claims and all possible changes and modifications within the senses and scopes of equivalents.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A method for manufacturing a multilayer substrate, the method comprising the steps of:
forming a via hole in a base material;
forming an interlayer connection conductor in the via hole;
stacking and integrating a plurality of the base materials on which the interlayer connection conductor is formed; and
causing a portion of a region in which the interlayer connection conductor is formed to be penetrated in a laminating direction.

2. The method for manufacturing a multilayer substrate according to claim 1, further comprising a step of growing a metal film on the interlayer connection conductor exposed to an inner side of a penetrated portion of the region.

3. The method for manufacturing a multilayer substrate according to claim 1, wherein:
the base material includes:
a first main surface on which conductive foil is formed; and
a second main surface on which no conductive foil is formed; and
in the step of stacking and integrating the plurality of the base materials, the base materials are stacked with second main surfaces of the base materials facing each other so that a plurality of the interlayer connection conductors are overlapped in a plan view.

4. The method for manufacturing a multilayer substrate according to claim 1, wherein:
the base material includes a main surface on which conductive foil is formed; and
the conductive foil includes:
a first main surface that is in contact with the base material; and
a second main surface that is not in contact with the base material; and
a surface roughness of the first main surface is larger than a surface roughness of the second main surface.

5. The method for manufacturing a multilayer substrate according to claim 1, wherein:
the base material includes a main surface on which metal foil is formed; and
in the step of stacking and integrating the plurality of the base materials, a first metal included in the metal foil and a second metal included in the interlayer connection conductor form a solid phase diffusion layer between the metal foil and the interlayer connection conductor.

6. The method for manufacturing a multilayer substrate according to claim 1, wherein, in the step of stacking and integrating the plurality of the base materials, a plurality of the interlayer connection layers formed on the base materials are joined to form an interlayer connection conductor including opposite end portions that are thinner than a central portion of the interlayer connection conductor, in the laminating direction of the base materials.

7. The method for manufacturing a multilayer substrate according to claim 1, wherein the multilayer substrate is a flexible cable.

8. The method for manufacturing a multilayer substrate according to claim 1, wherein the via hole has a tapered shape.

9. The method for manufacturing a multilayer substrate according to claim 1, wherein the step of stacking and integrating includes thermally pressing the base materials.

10. The method for manufacturing a multilayer substrate according to claim 1, wherein the via hole is barrel-shaped.

11. The method for manufacturing a multilayer substrate according to claim 2, wherein the metal film is formed by electrolytic plating.

12. The method for manufacturing a multilayer substrate according to claim 1, wherein the via hole is formed without using electroless plating.
